(19) United States
(12) Patent Application Publication
(10) Pub. No.: US 2024/0169220 A1
(43) Pub. Date: May 23, 2024

(54) COMPUTER SYSTEM AND MODEL EVALUATION METHOD

(71) Applicant: Hitachi, Ltd., Tokyo (JP)

(72) Inventors: Masayoshi MASE, Tokyo (JP); Kohei MATSUSHITA, Tokyo (JP); Masaki HAMAMOTO, Tokyo (JP); Masashi EGI, Tokyo (JP)

(21) Appl. No.: 18/379,537

(22) Filed: Oct. 12, 2023

(30) Foreign Application Priority Data
Nov. 22, 2022 (JP) 2022-186181

(51) Int. Cl. G06N 5/04

(52) U.S. Cl. CPC G06N 5/04

(57) ABSTRACT

A computer system is accessibly connected to model management information for managing model data, risk assessment management information for managing risk assessment data, and evaluation method management information for managing evaluation method data, and generates, as relation data, association of, model data, risk assessment data, and evaluation method data in a template. The computer system is configured to, when receiving an evaluation request, by referring to the model management information, search for model data of a model to be evaluated, search for the relation data associated with the model data, generate a template based on the relation data, store, in association with the relation data, an evaluation result based on an evaluation method corresponding to the evaluation method data associated with the relation data, and generate a report based on the template and the evaluation result.

### CLAIM OF PRIORITY

The present application claims priority from Japanese patent application JP 2022-186181 filed on Nov. 22, 2022, the content of which is hereby incorporated by reference into this application.

### BACKGROUND OF THE INVENTION

### 1. Field of the Invention

The present invention relates to a technique for supporting model evaluation.

### 2. Description of Related Art

For the management of models used in AI systems, it is important to evaluate the models from various viewpoints. Regarding this, technique described in U.S. Pat. No. 11,263,188B is known.

U.S. Pat. No. 11,263,188B describes generating information about AI evaluation based on a template defining evaluation items.

In the related art, evaluation viewpoints and evaluation methods are set in advance. However, the evaluation viewpoints and evaluation methods change. For example, the evaluation viewpoints and the evaluation methods often change in a model development stage. Therefore, it is necessary to generate a template according to the changes mentioned above. When generating templates manually, generation cost becomes an issue. Moreover, it is necessary to manage the templates and an evaluation result in association with each other, which causes a problem of management cost.

### SUMMARY OF THE INVENTION

It is an object of the present invention to provide a model evaluation technique that reduces template generation costs and evaluation result management costs.

A typical example of the invention disclosed in the present application is as follows. That is, a computer system includes a computer including a processor, a storage device connected to the processor, and a network interface connected to the processor, is accessibly connected to a model management information for managing model data including model-related items, risk assessment management information for managing risk assessment data including items related to model evaluation viewpoints, and evaluation method management information for managing evaluation method data including items related to evaluation methods, and is configured to: generate, as relation data, association of the model data, the risk assessment data, and the evaluation method data, included in a template defining a content of model evaluation, and register the generated data in template management information; when receiving an evaluation request including information about a model to be evaluated, by referring to the model management information, search for the model data of the model to be evaluated; search for the relation data associated with the searched model data, and generate the template based on the searched relation data; store, in association with the relation data, an evaluation result based on the evaluation method corresponding to the evaluation method data associated with the searched relation data; and generate a report based on the generated template and the evaluation result.

According to the invention, it is possible to realize a model evaluation technique that reduces template generation costs and evaluation result management costs. Problems, configurations, and effects other than those described above will be apparent from the following description of the embodiments.

### BRIEF DESCRIPTION OF THE DRAWINGS

FIG. 1 is a diagram illustrating a configuration example of a system according to a first embodiment;

FIG. 2 is a diagram illustrating a hardware configuration of a computer included in a model evaluation support system according to the first embodiment;

FIG. 3 is a diagram illustrating an example of model data stored in model management information according to the first embodiment;

FIG. 4A is a diagram illustrating an example of risk assessment data stored in risk assessment management information according to the first embodiment;

FIG. 4B is a diagram illustrating an example of the risk assessment data stored in the risk assessment management information according to the first embodiment;

FIG. 4C is a diagram illustrating an example of the risk assessment data stored in the risk assessment management information according to the first embodiment;

FIG. 5A is a diagram illustrating an example of evaluation method data stored in evaluation method management information according to the first embodiment;

FIG. 5B is a diagram illustrating an example of the evaluation method data stored in the evaluation method management information according to the first embodiment;

FIG. 5C is a diagram illustrating an example of the evaluation method data stored in the evaluation method management information according to the first embodiment;

FIG. 6 is a diagram illustrating an example of template management information according to the first embodiment;

FIG. 7 is a diagram illustrating an image of a template management method according to the first embodiment;

FIG. 8 is a diagram illustrating an example of evaluation result stored in evaluation result management information according to the first embodiment;

FIG. 9 is a flowchart illustrating an example of a template registration process executed by the model evaluation support system according to the first embodiment;

FIG. 10 is a diagram illustrating an example of a screen presented by the model evaluation support system according to the first embodiment;

FIG. 11 is a flowchart illustrating an example of an evaluation report generation process executed by the model evaluation support system according to the first embodiment;

FIG. 12 is a flowchart illustrating another example of the evaluation report generation process executed by the model evaluation support system according to the first embodiment;

FIG. 13 is a flowchart illustrating an example of a comparative evaluation report generation process executed by the model evaluation support system of the first embodiment;

FIG. 14 is a flowchart illustrating an example of an evaluation viewpoint recommendation process executed by the model evaluation support system according to the first embodiment;

FIG. 15 is a flowchart illustrating an example of an evaluation method recommendation process executed by the model evaluation support system according to the first embodiment; and

FIG. 16 is a flowchart illustrating an example of an improvement method recommendation process executed by the model evaluation support system according to the first embodiment.

### DESCRIPTION OF EMBODIMENTS

Hereinafter, embodiments of the present invention will be described with reference to the drawings. It is to be noted that the invention is not construed as being limited to the description of the embodiments below. It is easily understood by those skilled in the art that the specific configuration may be changed without departing from the spirit or gist of the invention.

In the configurations of the invention described below, the same or similar configurations or functions are denoted by the same reference numerals, and duplicate descriptions will not be repeated.

Notations such as “first”, “second”, and “third” in the description and the like are used to identify components, and do not necessarily limit the number or order.

### First Embodiment

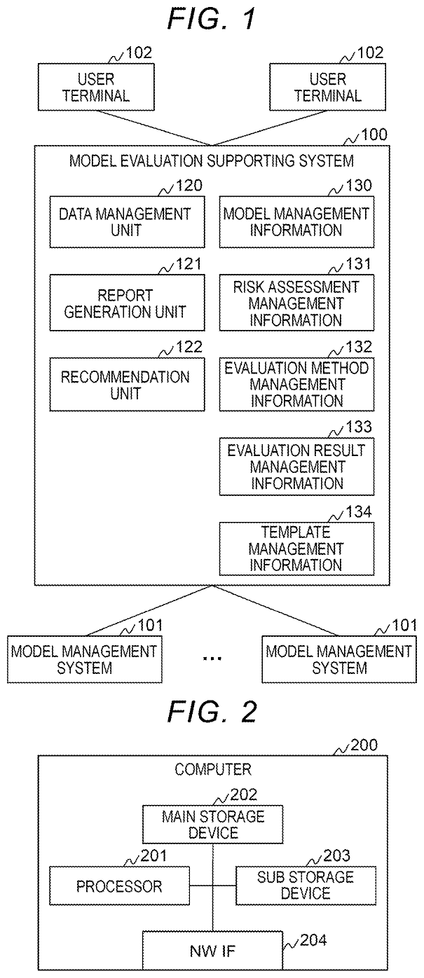

FIG. 1 is a diagram illustrating a configuration example of a system according to a first embodiment. FIG. 2 is a diagram illustrating a hardware configuration of a computer included in a model evaluation support system 100 according to the first embodiment.

The system includes the model evaluation support system 100, a plurality of model management systems 101 and a plurality of user terminals 102. The model evaluation support system 100 and the user terminals 102 are connected via a network (not shown). The model evaluation support system 100 and the model management systems 101 are connected via a network (not shown). The network may be a Wide Area Network (WAN), a Local Area Network (LAN), or the like, and the method of connection may be either wired or wireless method. Note that the invention is not limited to the numbers of model management systems 101 and user terminals 102.

The model management system 101 is a system operated by a model provider or developer. The model management system 101 includes a system for managing a model, data (training data) used for generating the model, a program used for generating the model, data (verification data) used for verifying the model, a program used for verifying the model, verification result and the like. The model management system 101 also includes a system that conducts business using the models.

The user terminal 102 is a terminal operated by a user who uses the model. Although not illustrated, the terminal includes a processor, a memory, a network interface, an input device, and an output device. The input device is a keyboard, a mouse, a touch panel, or the like. The output device is a display or the like.

The model evaluation support system 100 is a system that supports generation of a template, generation of a model evaluation report based on the template, and the like. The template is data that defines a content of the model evaluation, and includes information on a model to be evaluated, an evaluation viewpoint, an evaluation method, an evaluation standard, an evaluation index, and the like.

The model evaluation support system 100 includes, for example, a computer 200 as shown in FIG. 2. The computer 200 includes a processor 201, a main storage device 202, a sub storage device 203 and a network interface 204. The hardware elements are connected to each other via a bus. Note that the model evaluation support system 100 may include an input device and an output device.

The processor 201 executes a program stored in the main storage device 202. The processor 201 operates as a functional unit (module) that implements a specific function by executing processes according to the program. In the following description, when a process is described with a functional unit as a subject, it indicates that the processor 201 is executing a program for implementing the functional unit.

The main storage device 202 is a memory and the like, and stores programs executed by the processor 201 and information used by the programs. The main storage device 202 is also used as a work area temporarily used by the program. The sub storage device 203 is a hard disk drive (HDD), a solid state drive, and the like, and permanently stores data. The network interface 204 is an interface for communicating with an external device via a network.

The model evaluation support system 100 stores model management information 130, risk assessment management information 131, evaluation method management information 132, evaluation result management information 133 and template management information 134. The model evaluation support system 100 also includes a data management unit 120, a report generation unit 121 and a recommendation unit 122.

The model management information 130 is information for managing model data that is data related to the model. The risk assessment management information 131 is information for managing risk assessment data that is data related to evaluation viewpoint. The evaluation method management information 132 is information for managing evaluation method data that is data related to evaluation method. The evaluation result management information 133 is information for managing evaluation result data that is data including evaluation result.

The model management information 130, the risk assessment management information 131, and the evaluation method management information 132 may be stored by the model management system 101.

The template management information 134 is information for managing relation data that represents relationships among the model data, the risk assessment data, and the evaluation method data included in the template. The template is data that defines the evaluation viewpoint and the evaluation method of the model.

The data management unit 120 manages input and output of data. The report generation unit 121 uses the template to generate a report on model evaluation. The recommendation unit 122 uses the template to make a recommendation.

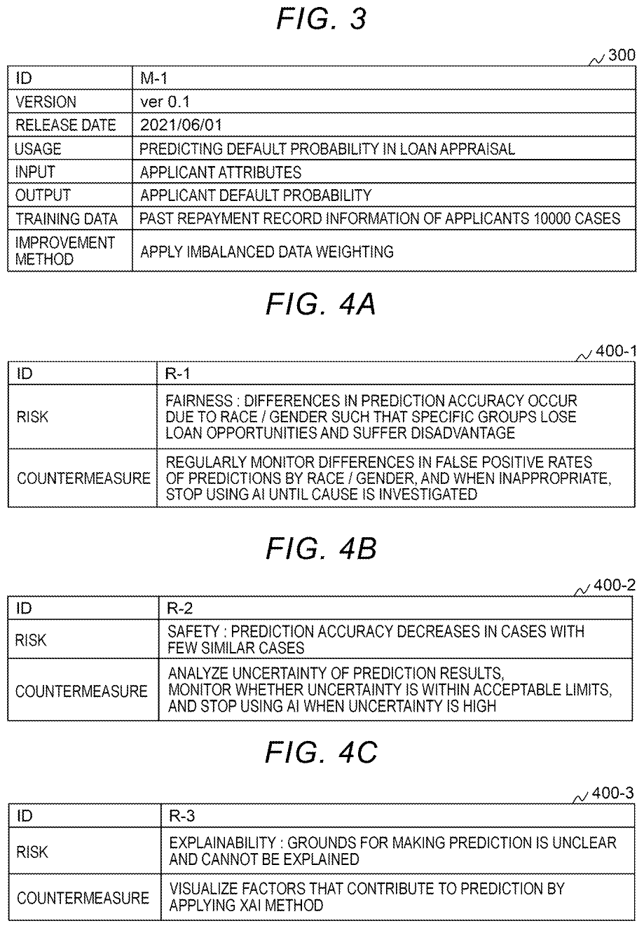

FIG. 3 is a diagram illustrating an example of model data stored in the model management information 130 according to the first embodiment.

Model data 300 includes, as an item, ID, version, release date, usage, input, output, training data, and improvement method. Note that the items described above are merely examples, and the invention is not limited thereto. For example, training parameters may be included as items.

“ID” is an item for managing identification information of the model data 300. “Version” is an item for managing the version of a model, which is an example of model identification information. “Release date” is an item for managing the release date of the model. “Usage” is an item for managing the usage of the model. “Input” is an item for managing data to be input to the model. “Output” is an item for managing the output of the model. “Training data” is an item for managing information related to training data used for model training. The “Training data” manages, for example, the type and number of training data. “Improvement method” is an item for managing a method for improving the model. The “Improvement method” may be left blank.

FIGS. 4A, 4B, and 4C are diagrams illustrating an example of risk assessment data stored in the risk assessment management information 131 according to the first embodiment.

The risk assessment data 400-1, 400-2, and 400-3 include, as an item, an ID, a risk, and a countermeasure. Note that the items described above are merely examples, and the invention is not limited thereto.

“ID” is an item for managing identification information of the risk assessment data. “Risk” is an item for managing information on evaluation viewpoints. “Countermeasure” is an item for managing information relating to countermeasures when the evaluation result of the evaluation viewpoint does not satisfy a predetermined condition.

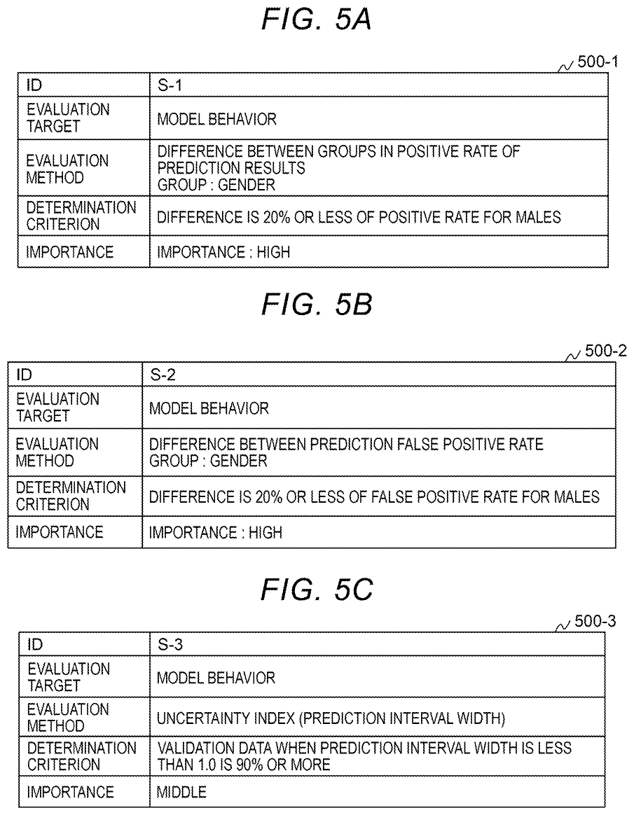

FIGS. 5A, 5B, and 5C are diagrams illustrating examples of evaluation method data stored in the evaluation method management information 132 according to the first embodiment.

The evaluation method data 500-1, 500-2, and 500-3 include, as an item, an ID, an evaluation target, an evaluation method, a determination criteria, and an importance. Note that the items described above are merely examples, and the invention is not limited thereto.

“ID” is an item for managing identification information of the evaluation method data 500. “Evaluation target” is an item for managing information about an evaluation target. “Evaluation method” is an item that stores information on evaluation methods. “Determination criteria” is an item for managing information on determination criteria of good or bad in evaluation based on the evaluation method. “Importance” is an item for managing the importance of the evaluation method.

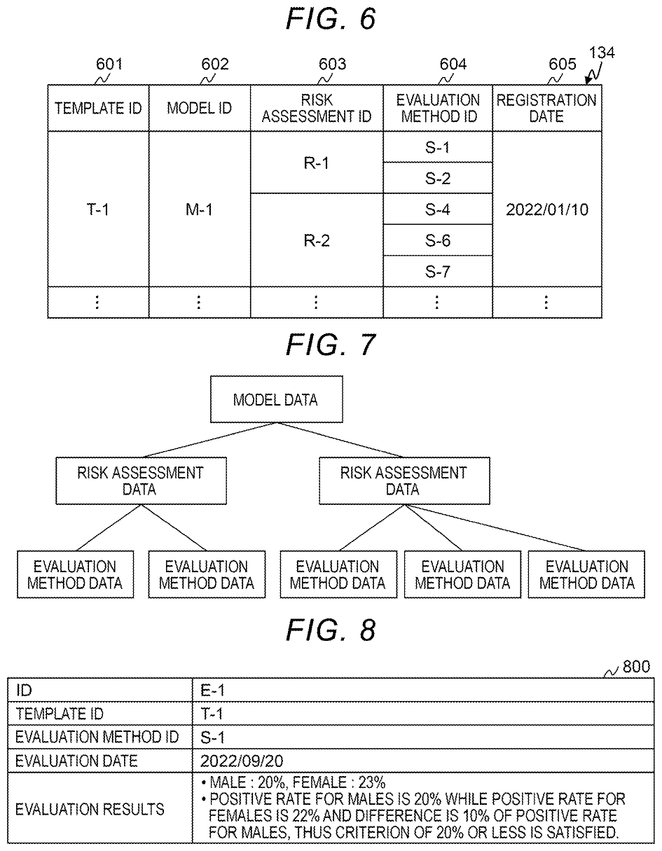

FIG. 6 is a diagram illustrating an example of the template management information 134 according to the first embodiment. FIG. 7 is a diagram illustrating an image of a template management method according to the first embodiment.

The template management information 134 stores entries including a template ID 601, a model ID 602, a risk assessment ID 603, an evaluation method ID 604, and a registration date 605. One entry corresponds to one piece of relation data. One template is generated from one piece of relation data. It should be noted that the fields included in the entry are just examples and are not limited thereto.

The template ID 601 is a field that stores identification information of the relation data. Since there is a one-to-one relationship between the relation data and the template, the identification information of the relation data is used as the identification information of the template.

The model ID 602 is a field that stores identification information of the model data 300 corresponding to the model to be evaluated. The risk assessment ID 603 is a field that stores identification information of the risk assessment data 400 corresponding to the evaluation viewpoint of the model. The evaluation method ID 604 is a field that stores identification information of the evaluation method data 500 corresponding to the evaluation method for evaluating the evaluation viewpoint. The registration date 605 is a field that stores a registration date of the relation data.

The relation data is information for managing connection relationships as shown in FIG. 7. In this embodiment, the amount of data can be reduced because there is no need to manage the template itself. In addition, setting the connection relationship of each data facilitates template generation and updating, so that the template generation cost can be reduced.

FIG. 8 is a diagram showing an example of evaluation result stored in the evaluation result management information 133 according to the first embodiment.

The evaluation result data 800 includes, as an item, an ID, a template ID, an evaluation method ID, an evaluation date, and an evaluation result. Note that the items described above are merely examples, and the invention is not limited thereto.

“ID” is an item for managing identification information of the evaluation result data 800. “Template ID” is an item for managing identification information of a template (relation data) used in evaluation. “Evaluation method ID” is an item for managing identification information of the evaluation method data 500. “Evaluation date” is an item for managing the date and time of performing evaluation. “Evaluation result” is an item for managing an evaluation result.

By including the “template ID”, it is possible to know which template the evaluation result is based on. Also, by including the “evaluation method ID”, it is possible to know which evaluation method of the template corresponds to the evaluation result.

The model evaluation support system 100 receives registration of the model data 300, the risk assessment data 400 and the evaluation method data 500 from the model management system 101. In this embodiment, evaluation viewpoints and evaluation methods can be added and changed at any timing.

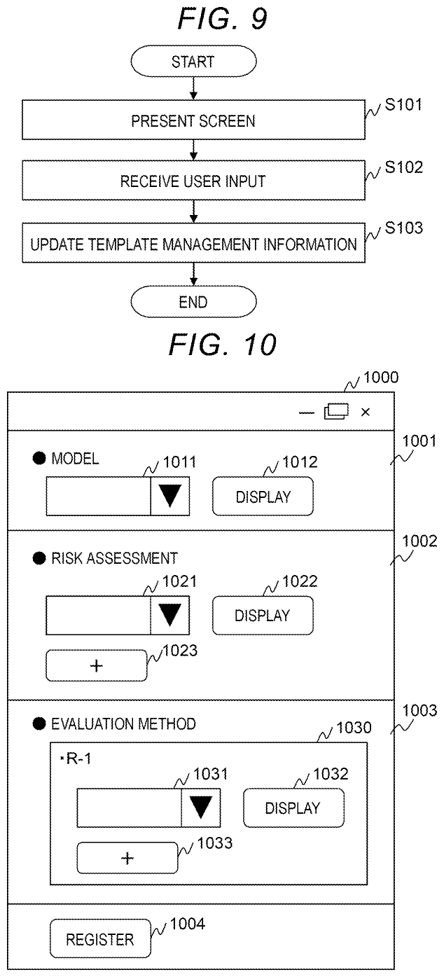

FIG. 9 is a flowchart illustrating an example of a template registration process executed by the model evaluation support system 100 according to the first embodiment. FIG. 10 is a diagram illustrating an example of a screen presented by the model evaluation support system 100 according to the first embodiment.

When receiving a template registration request from the model management system 101 or the user terminal 102, the model evaluation support system 100 executes the process described below. Note that the template registration process can be executed at any timing.

The data management unit 120 presents a screen 1000 as shown in FIG. 10 (step S101) and receives user input (step S102).

The screen 1000 includes a model selection area 1001, a risk assessment selection area 1002, an evaluation method selection area 1003, and a registration button 1004.

The model selection area 1001 is an area provided to select a model to apply the template, and includes a selection box 1011 and a display button 1012.

The selection box 1011 is a box provided to select a model. The identification information of the model data 300 is displayed in the selection box 1011 in a pull-down format. The display button 1012 is an operation button provided to display the model data 300 selected in the selection box 1011. When the display button 1012 is operated, the data management unit 120 acquires the selected model data 300 from the model management information 130 and displays the acquired data. The model data 300 may be displayed in the screen 1000 or may be displayed as another screen.

The risk assessment selection area 1002 is an area provided to select the evaluation viewpoint to be included in the template, that is, the risk assessment data 400, and includes a selection box 1021, a display button 1022, and an add button 1023.

The selection box 1021 is a box provided to select an evaluation viewpoint. The identification information of the risk assessment data 400 is displayed in the selection box 1021 in a pull-down format. The display button 1022 is an operation button provided to display the risk assessment data 400 selected in the selection box 1021. When the display button 1022 is operated, the data management unit 120 acquires the selected risk assessment data 400 from the risk assessment management information 131 and displays the acquired data. The risk assessment data 400 may be displayed in the screen 1000 or may be displayed as another screen.

The add button 1023 is an operation button provided to add the selection box 1021 and the display button 1022 for setting a new evaluation viewpoint. When the add button 1023 is operated, the data management unit 120 adds the selection box 1021 and the display button 1022 to the risk assessment selection area 1002.

The evaluation method selection area 1003 is an area provided to select the evaluation method to be included in the template, that is, the evaluation method data 500, and includes a selection box 1030. The same number of selection boxes 1030 as the evaluation viewpoints selected in the risk assessment selection area 1002 are displayed in the evaluation method selection area 1003.

The selection box 1030 is an area provided to select an evaluation method of one evaluation viewpoint, and includes a selection box 1031, a display button 1032, and an add button 1033.

The selection box 1031 is a box provided to select an evaluation method. The identification information of the evaluation method data 500 is displayed in the selection box 1031 in a pull-down format. The display button 1032 is an operation button provided to display the evaluation method data 500 selected in the selection box 1031. When the display button 1032 is operated, the data management unit 120 acquires the selected evaluation method data 500 from the evaluation method management information 132 and displays the acquired data. The evaluation method data 500 may be displayed in the screen 1000 or may be displayed as another screen.

The add button 1033 is an operation button provided to add the selection box 1031 and the display button 1032 for setting a new evaluation method. When the add button 1033 is operated, the data management unit 120 adds the selection box 1031 and the display button 1032 to the selection box 1030.

The registration button 1004 is an operation button provided to instruct registration of a template. When the registration button 1004 is operated, user input including information on each data selected in the model selection area 1001, the risk assessment selection area 1002, and the evaluation method selection area 1003 is transmitted to the model evaluation support system 100.

The data management unit 120 updates the template management information 134 based on the user input (step S103).

Specifically, the data management unit 120 adds an entry to the template management information 134 and sets identification information in the template ID 601 of the added entry. The data management unit 120 sets, in the model ID 602 of the added entry, the identification information of the model data 300 selected in the model selection area 1001. The data management unit 120 adds, in the risk assessment ID 603 of the added entry, the same number of rows as the risk assessment data 400 selected in the risk assessment selection area 1002, and sets the identification information of the selected risk assessment data 400 in each row. The data management unit 120 adds the same number of rows as the evaluation method data 500 selected in the selection box 1030 to the rows of the risk assessment data 400, and sets the identification information of the selected evaluation method data 500 in each row. The current date and time is set in the registration date 605.

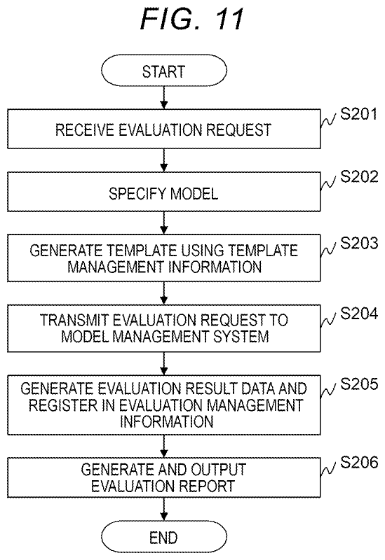

FIG. 11 is a flowchart illustrating an example of an evaluation report generation process executed by the model evaluation support system 100 according to the first embodiment.

The model evaluation support system 100 receives an evaluation request including information for identifying a model to be evaluated (step S201). The information for identifying the model is, for example, identification information of the model data 300 or the version of the model.

The report generation unit 121 specifies the model to be evaluated based on the information included in the evaluation request (step S202).

Specifically, the report generation unit 121 refers to the model management information 130 and searches for the model data 300 including the item values corresponding to the information included in the evaluation request.

The report generation unit 121 generates a template to be applied to the specified model based on the template management information 134 (step S203).

Specifically, the report generation unit 121 searches for the entry of the model ID 602 in which the identification information of the model data 300 specified in step S202 is stored. The report generation unit 121 acquires data from each of the model management information 130, the risk assessment management information 131, and the evaluation method management information 132 based on the searched entry, and generates a template using the acquired data.

The report generation unit 121 transmits an evaluation request including the model data 300 and the evaluation method data 500 to the model management system 101 that evaluates the model (step S204). The model management system 101 receiving the request executes a model evaluation process based on the model data 300 and the evaluation method data 500 and transmits the identification information of the evaluation method data 500 and the evaluation result to the model evaluation support system 100.

In the evaluation process, calculation of an evaluation index, determination based on the evaluation index, and the like are performed. The determination may include text indicating whether the evaluation criteria are met.

When receiving the evaluation result from the model management system 101, the report generation unit 121 instructs the data management unit 120 to register the evaluation result data 800. The instruction includes the identification information of the template, the identification information of the evaluation method data 500, and the evaluation result. The data management unit 120 generates the evaluation result data 800 including the evaluation result, and registers the generated data in the evaluation result management information 133 (step S205). For example, the current date and time is set in the “evaluation date” of the evaluation result data 800. The data management unit 120 outputs the evaluation result data 800 to the report generation unit 121.

By the process of step S205, the template and the evaluation result can be managed in association with each other. In this embodiment, since the template itself is not stored, the data capacity can be reduced.

After completing the evaluation corresponding to all the evaluation method data 500, the report generation unit 121 generates and outputs an evaluation report based on the template and the evaluation result data 800 (step S206). The evaluation report can be generated, for example, by embedding the evaluation result in the template.

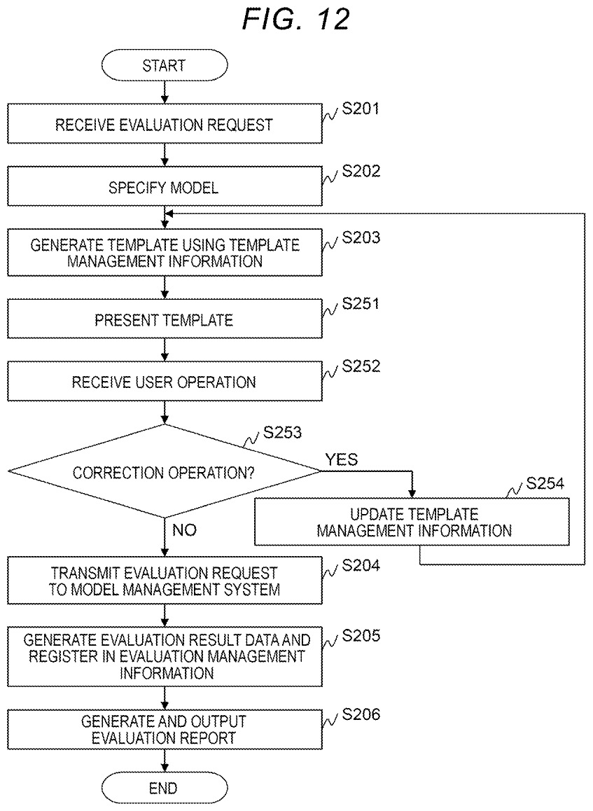

FIG. 12 is a flowchart illustrating another example of the evaluation report generation process executed by the model evaluation support system 100 according to the first embodiment.

After the processes from step S201 to step S203 are executed, the report generation unit 121 calls the data management unit 120. The data management unit 120 presents the template (step S251) and provides an interface for correcting the template. The user can perform either a template correction operation or an evaluation continuation operation via the interface.

When receiving a user operation via the interface (step S252), the data management unit 120 determines whether the user operation is the template correction operation (step S253).

If the received user operation is the template correction operation, the data management unit 120 updates the template management information 134 based on the correction operation (step S254), and then returns to step S203.

If the received user operation is an evaluation continuation operation, the data management unit 120 calls the report generation unit 121. The report generation unit 121 executes the processes from step S204 to step S206.

Templates can be generated interactively in this way.

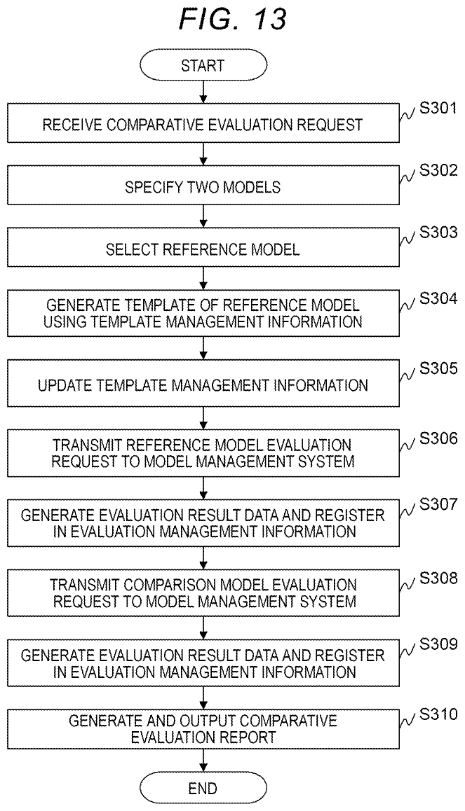

FIG. 13 is a flowchart illustrating an example of a comparative evaluation report generation process executed by the model evaluation support system 100 according to the first embodiment.

The model evaluation support system 100 receives a comparative evaluation request including identification information of two models to be compared (step S301).

The report generation unit 121 specifies the two models based on the information included in the comparative evaluation request (step S302). The method of specifying the model is the same as in step S202.

The report generation unit 121 selects a reference model from the two models (step S303). For example, the latest model is selected as the reference model. Information on the model selected as the reference model may be included in the comparative evaluation request. A model that is not the reference model is hereinafter referred to as a comparison model.

The report generation unit 121 generates a template to be applied to the reference model based on the template management information 134 (step S304). The process of step S304 is the same as the process of step S203.

The report generation unit 121 instructs the data management unit 120 to register a comparison model template. The instruction includes the identification information of the template of the reference model and the identification information of the model data 300 of the comparison model. The data management unit 120 updates the template management information 134 based on the instruction (step S305). The data management unit 120 outputs the identification information of the newly registered template to the report generation unit 121.

Specifically, the data management unit 120 adds an entry to the template management information 134 and sets an identification information of the template in the template ID 601 of the added entry. The data management unit 120 also sets, in the model ID, the identification information of the model data 300 of the comparison model. Furthermore, the data management unit 120 copies the content of the template of the reference model to the risk assessment ID and the evaluation method ID 604 of the added entry. The current date and time is set in the registration date 605.

The report generation unit 121 transmits an evaluation request including the model data 300 of the reference model and the evaluation method data 500 to the model management system 101 that evaluates the model (step S306).

When receiving the evaluation result from the model management system 101, the report generation unit 121 instructs the data management unit 120 to register the evaluation result data 800. The data management unit 120 generates the evaluation result data 800 including the evaluation result, and registers the generated data in the evaluation result management information 133 (step S307). The data management unit 120 outputs the evaluation result data 800 to the report generation unit 121.

The report generation unit 121 transmits an evaluation request including the model data 300 of the comparison model and the evaluation method data 500 to the model management system 101 that evaluates the model (step S308).

When receiving the evaluation result from the model management system 101, the report generation unit 121 instructs the data management unit 120 to register the evaluation result data 800. The data management unit 120 generates the evaluation result data 800 including the evaluation result, and registers the generated data in the evaluation result management information 133 (step S309). The data management unit 120 outputs the evaluation result data 800 to the report generation unit 121.

The report generation unit 121 generates and outputs a comparative evaluation report based on the respective templates of the reference model and the comparison model and the evaluation result data 800 (step S310). The comparative evaluation report includes evaluation indexes and the like for each model. The comparative evaluation report includes, for example, information regarding changes in the evaluation index. The comparative evaluation report may include comments and the like regarding differences in the evaluation index.

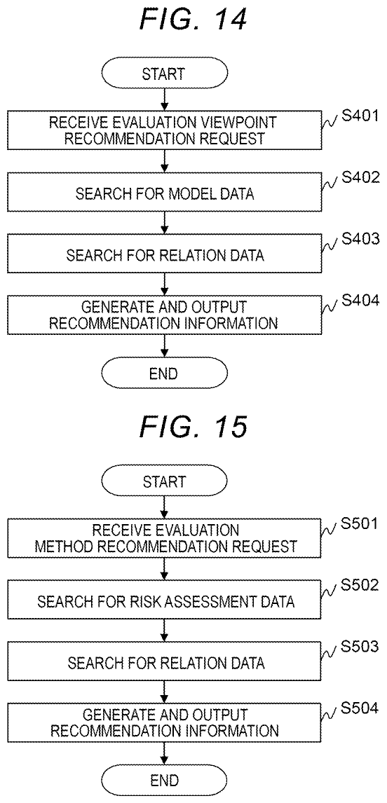

FIG. 14 is a flowchart illustrating an example of an evaluation viewpoint recommendation process executed by the model evaluation support system 100 according to the first embodiment.

The model evaluation support system 100 receives an evaluation viewpoint recommendation request (step S401). The request includes information about characteristics of the model. The information about the characteristics of the model is, for example, the usage of the model.

The recommendation unit 122 refers to the model management information 130 and searches for the model data 300 of the model having the specified characteristic (step S402).

The recommendation unit 122 refers to the template management information 134 based on the identification information of the searched model data 300 to search for related relation data (step S403).

The recommendation unit 122 generates and outputs recommendation information based on the risk assessment data 400 associated with the relation data (step S404). For example, recommendation information that displays the risk assessment data 400 itself can be considered.

There are cases where a plurality of pieces of relation data are searched. In this case, the recommendation unit 122 may generate the recommendation information based on the risk assessment data 400 of each relation data. In addition, the recommendation unit 122 may analyze the frequency of appearance of the risk assessment data 400 and generate the recommendation information based on the risk assessment data 400 with high frequency.

By referring to the recommendation information, the user can grasp the evaluation viewpoint to be focused on in the evaluation of the model.

FIG. 15 is a flowchart illustrating an example of an evaluation method recommendation process executed by the model evaluation support system 100 according to the first embodiment.

The model evaluation support system 100 receives an evaluation method recommendation request (step S501). The request includes information about the evaluation viewpoint.

The recommendation unit 122 refers to the risk assessment management information 131 and searches for the risk assessment data 400 corresponding to a specified evaluation viewpoint (step S502).

The recommendation unit 122 refers to the template management information 134 based on the identification information of the searched risk assessment data 400 to search for related relation data (step S503).

The recommendation unit 122 generates and outputs recommendation information based on the evaluation method data 500 associated with the relation data (step S504).

There are cases where a plurality of pieces of relation data are searched. In this case, the recommendation unit 122 may generate recommendation information based on the evaluation method data 500 of each relation data. In addition, the recommendation unit 122 may analyze the frequency of appearance of the evaluation method data 500 and generate the recommendation information based on the evaluation method data 500 with high frequency.

By referring to the recommendation information, the user can grasp the evaluation method to be adopted in the evaluation of the model.

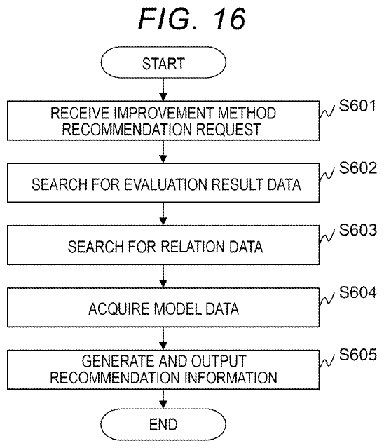

FIG. 16 is a flowchart illustrating an example of an improvement method recommendation process executed by the model evaluation support system 100 according to the first embodiment.

The model evaluation support system 100 receives an improvement method recommendation request (step S601). The request includes information about an item to be improved. The information about the item to be improved is, for example, a name of the evaluation item and a target value of the evaluation item.

The recommendation unit 122 refers to the evaluation result management information 133 and searches for the evaluation result data 800 including the evaluation result of the item to be improved (step S602).

The recommendation unit 122 specifies related relation data based on the evaluation result data 800 (step S603).

The recommendation unit 122 acquires the model data 300 from the model management information 130 based on the specified relation data (step S604).

The recommendation unit 122 generates and outputs information on the improvement method included in the model data 300 as recommendation information (step S605).

By referring to the recommendation information, the user can grasp the improvement method of the model.

According to the invention, the template generation costs and the evaluation result management costs can be reduced. Templates can also be used to present information about the evaluation viewpoints, the evaluation methods, and the improvement methods. This can support template generation and model training.

Note that the model evaluation support system 100 may have functions for performing model training, model evaluation, and the like. In this case, the model management information 130 may store the model itself. The model evaluation support system 100 also stores training data and verification data.

It is to be noted that the invention is not limited to the embodiments described above, and includes various modifications. Further, for example, the configuration according to the embodiments described above has been described in detail in order to describe the invention in an easy-to-understanding manner, and are not necessarily limited to those having all the configurations described above. In addition, it is possible to add, delete, and replace other configurations for a part of the configuration of each embodiment.

Each of the configurations, functions, processing units, processing means, and the like described above may be realized by hardware by designing a part or all of those with, for example, an integrated circuit. In addition, the invention can also be realized by software program code for realizing the functions of the embodiments. In this case, a storage medium storing the program code is provided to a computer, and a processor included in the computer reads the program code stored in the storage medium. In this case, the program code itself read from the storage medium implement the functions of the embodiments described above, and the program code itself and the storage medium storing the program code are included the invention. As a storage medium for supplying such a program code, for example, flexible disks, CD-ROMs, DVD-ROMs, hard disks, solid state drives (SSD), optical disks, magneto-optical disks, CD-Rs, magnetic tapes, non-volatile memory cards, and ROMs, and the like are used.

Further, the program code for realizing the functions described in the present embodiments may be realized by a wide range of programs or script languages such as assembler, C/C++, perl, Shell, PHP, Python, and Java (registered trademark).

Further, the software program code for realizing the functions of the embodiments is distributed through a network, so that the program code is stored in a storage unit such as a hard disk or a memory of a computer or a storage medium such as a CD-RW or a CD-R, and a processor included in the computer may read and execute the program code stored in the storage unit or the storage medium.

In the embodiments described above, the control lines and the information lines show those considered to be necessary for description, and it is not necessarily limited that all the control lines and information lines on the product are shown. All components may be interconnected.

What is claimed is:

1. A computer system, comprising:
a computer including a processor, a storage device connected to the processor, and a network interface connected to the processor, wherein
the computer system is accessibly connected to a model management information for managing model data including model-related items, risk assessment management information for managing risk assessment data including items related to model evaluation viewpoints, and evaluation method management information for managing evaluation method data including items related to evaluation methods, and configured to:
generate, as relation data, association of the model data, the risk assessment data, and the evaluation method data, included in a template defining a content of model evaluation, and register the generated data in template management information;
when receiving an evaluation request including information about a model to be evaluated, by referring to the model management information, search for the model data of the model to be evaluated;
search for the relation data associated with the searched model data;
generate the template based on the searched relation data;
store, in association with the relation data, an evaluation result based on the evaluation method corresponding to the evaluation method data associated with the searched relation data; and
generate a report based on the generated template and the evaluation result.

2. The computer system according to claim 1, configured to:
when receiving a comparative evaluation request including information for specifying a first model and a second model for comparison with each other, by referring to the template management information, search for first relation data associated with the model data of the first model;
generate second relation data of the second model based on the first relation data and register the generated data in the template management information;
store, in association with the first relation data, an evaluation result of the evaluation method corresponding to the evaluation method data included in the first relation data of the first model;
store, in association with the second relation data, an evaluation result of the evaluation method corresponding to the evaluation method data included in the second relation data of the second model; and
compare the first model and the second model based on the evaluation result of the first model and the evaluation result of the second model, and generate a report on the result of the comparison.

3. The computer system according to claim 1, configured to:
when receiving an evaluation viewpoint recommendation request including information about characteristics of a model, by referring to the model management information, search for the model data of the model having a specified characteristic;
by referring to the template management information, search for the relation data associated with the searched model data; and
generate recommendation information to display the evaluation method data associated with the searched relation data.

4. The computer system according to claim 1, configured to:
when receiving an evaluation method recommendation request including information about an evaluation viewpoint, by referring to the risk assessment management information, search for the risk assessment data corresponding to a specified evaluation viewpoint;
by referring to the template management information, search for the relation data associated with the searched risk assessment data;
generate recommendation information to display the evaluation method data associated with the searched relation data.

5. The computer system according to claim 1,
wherein the model data includes, as an item, information on an improvement method of the model, and
wherein the computer system is configured to:
when receiving an improvement method recommendation request including information about an evaluation method, by referring to the evaluation method management information, search for the evaluation method data corresponding to a specified evaluation method;
by referring to the template management information, search for the relation data associated with the searched evaluation method data;
acquire the model data associated with the searched relation data from the model management information; and
generate recommendation information to display information about an improvement method of the model included in the acquired model data.

6. The computer system according to claim 1, configured to:
present the generated template to a user; and
provide an interface for correcting the relation data.

7. A model evaluation method executed by a computer system,
wherein the computer system
comprises a computer including a processor, a storage device connected to the processor, and a network interface connected to the processor, and
is accessibly connected to a model management information for managing model data including model-related items, risk assessment management information for managing risk assessment data including items related to model evaluation viewpoints, and evaluation method management information for managing evaluation method data including items related to evaluation methods,
wherein the model evaluation method comprises:
by the computer, generating, as relation data, association of the model data, the risk assessment data, and the evaluation method data, included in a template defining a content of model evaluation, and registering the generated data in template management information;
by the computer, when receiving an evaluation request including information about a model to be evaluated, by referring to the model management information, searching for the model data of the model to be evaluated;
by the computer, searching for relation data associated with the searched model data;
by the computer, generating the template based on the searched relation data;
by the computer, storing, in association with the relation data, an evaluation result based on the evaluation method corresponding to the evaluation method data associated with the searched relation data; and
by the computer, generating a report based on the generated template and the evaluation result.

8. The model evaluation method according to claim 7, comprising:
by the computer, when receiving a comparative evaluation request including information for specifying a first model and a second model for comparison, by referring to the template management information, searching for first relation data associated with the model data of the first model;
by the computer, generating second relation data of the second model based on the first relation data and registering the generated data in the template management information;
by the computer, storing, in association with the first relation data, an evaluation result of the evaluation method corresponding to the evaluation method data included in the first relation data of the first model;
by the computer, storing, in association with the second relation data, an evaluation result of the evaluation method corresponding to the evaluation method data included in the second relation data of the second model; and
by the computer, comparing the first model and the second model based on the evaluation result of the first model and the evaluation result of the second model, and generating a report on the result of the comparison.

9. The model evaluation method according to claim 7, comprising:
by the computer, when receiving an evaluation viewpoint recommendation request including information about characteristics of a model, by referring to the model management information, searching for the model data of the model having a specified characteristic;
by the computer, by referring to the template management information, searching for the relation data associated with the searched model data; and
by the computer, generating recommendation information to display the evaluation method data associated with the searched relation data.

10. The model evaluation method according to claim 7, comprising:
by the computer, when receiving an evaluation method recommendation request including information about an evaluation viewpoint, by referring to the risk assessment management information, searching for the risk assessment data corresponding to a specified evaluation viewpoint;
by the computer, by referring to the template management information, searching for the relation data associated with the searched risk assessment data; and
by the computer, generating recommendation information to display the evaluation method data associated with the searched relation data.

11. The model evaluation method according to claim 7, wherein the model data includes, as an item, information on an improvement method of the model, and
the computer system includes:
by the computer, when receiving an improvement method recommendation request including information about an evaluation method, by referring to the evaluation method management information, searching for the evaluation method data corresponding to a specified evaluation method;
by the computer, by referring to the template management information, searching for the relation data associated with the searched evaluation method data;
by the computer, acquiring the model data associated with the searched relation data from the model management information;
by the computer, generating recommendation information to display information about an improvement method of the model included in the acquired model data.

12. The model evaluation method according to claim 7, comprising:
by the computer, presenting the generated template to a user; and
by the computer, providing an interface for correcting the relation data.
